(19) United States
(12) Patent Application Publication
(10) Pub. No.: US 2026/0326550 A1
(43) Pub. Date: Oct. 22, 2026

(54) IN-VEHICLE SYSTEM, VEHICLE, AND INFORMATION PROCESSING DEVICE

(71) Applicant: TOYOTA JIDOSHA KABUSHIKI KAISHA, Toyota-shi (JP)

(72) Inventors: Kazuyuki SHIGA, Nisshin-shi (JP); Sara YAMAFUJI, Miyoshi-shi (JP); Seiichi TANAKA, Toyota-shi (JP); Junichi TODAKA, Seto-shi (JP); Kanako MATSUMOTO, Shinagawa-ku (JP); Akinori SHIN, Toyota-shi (JP); Yu YOKOYAMA, Ogaki-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 19/642,808

(22) Filed: Apr. 9, 2026

(30) Foreign Application Priority Data
Apr. 16, 2025 (JP) 2025-067725

(51) Int. Cl. B60K 35/10; B60K 35/21; B60K 35/215; B60K 35/22; B60K 35/50; G06F 3/04886

(52) U.S. Cl. CPC B60K 35/10; B60K 35/213; B60K 35/215; B60K 35/22; B60K 35/50; G06F 3/04886; B60K 2360/1434; B60K 2360/1442; B60K 2360/1468

(57) ABSTRACT

A system includes: a display device including a plurality of displays that include at least a pair of first displays and a second display; and one or more processors, wherein: the first displays are respectively disposed at positions on both lateral sides of a steering wheel, on a driver's seat forward side in a vehicle cabin, while protruding to a vehicle rearward side relative to a meter arranged in front of the steering wheel, and include touch panels; the second display is disposed at an intermediate position between a driver's seat and an assistant driver's seat on the driver's seat forward side in the vehicle cabin; and the one or more processors display a software keyboard for character input to the second display, on one of the first displays, when the character input is requested on the second display.

### CROSS-REFERENCE TO RELATED APPLICATION

This application claims priority to Japanese Patent Application No. 2025-067725 filed on Apr. 16, 2025. The disclosure of the above-identified application, including the specification, drawings, and claims, is incorporated by reference herein in its entirety.

### BACKGROUND

### 1. Technical Field

The present disclosure relates to an in-vehicle system, a vehicle, and an information processing device.

### 2. Description of Related Art

There is known a vehicle including a steering wheel, a center display unit provided forward of a steering wheel, and a side display unit provided on one side or both sides of the center display unit in a vehicle-width direction (for example, Japanese Patent No. 7306210 (JP 7306210 B)).

Further, as a technology in which a multi-function peripheral (MFP) having a plurality of functions that includes a print function is remotely operated by a portable terminal, there is known a technology in which a software keyboard for character input is displayed on a remote operation screen of the portable terminal (see, for example, Japanese Unexamined Patent Application Publication No. 2022-138660 (JP 2022-138660 A)).

### SUMMARY

The present disclosure provides an in-vehicle system, a vehicle, and an information processing device that enhance the convenience when a user (driver) uses a display device that is included in the in-vehicle system and that includes a plurality of display units.

An in-vehicle system according to a first aspect of the present disclosure includes: a display device including a plurality of displays that includes at least a pair of first displays and a second display; and one or more processors configured to control the display device, wherein: the first displays include touch panels; the first displays are respectively disposed at positions on both lateral sides of a steering wheel, on a driver's seat forward side in a vehicle cabin, so as to protrude to a vehicle rearward side relative to a meter, the meter being arranged in front of the steering wheel; the second display is disposed at an intermediate position between a driver's seat and an assistant driver's seat on the driver's seat forward side in the vehicle cabin; and the one or more processors are configured to execute displaying a software keyboard for character input to the second display, on one of the first displays, when the character input is requested on the second display.

A vehicle according to a second aspect of the present disclosure includes the in-vehicle system according to the first aspect of the present disclosure.

An information processing device according to a third aspect of the present disclosure includes a one or more processors configured to control a display device including a plurality of displays that includes at least a pair of first displays and a second display, wherein: the first displays include touch panels; the first displays are respectively disposed at positions on both lateral sides of a steering wheel, on a driver's seat forward side in a vehicle cabin, so as to protrude to a vehicle rearward side relative to a meter, the meter being arranged in front of the steering wheel; the second display is disposed at an intermediate position between a driver's seat and an assistant driver's seat on the driver's seat forward side in the vehicle cabin; and the one or more processors are configured to execute displaying a software keyboard for character input to the second display, on one of the first displays, when the character input is requested on the second display.

Further, as another aspect, there is an information processing method that is executed by the above information processing device, a program for causing a computer to execute the information processing method, or a computer-readable storage medium in which the program is stored in a non-transitory manner.

With the present disclosure, it is possible to enhance the convenience when a user (driver) uses a display device that is included in an in-vehicle system and that includes a plurality of display units.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram showing the appearance of a vehicle cabin forward portion of a vehicle according to an embodiment;

FIG. 2 is a diagram showing the schematic configuration of a display device and the periphery thereof;

FIG. 3 is a block diagram schematically showing an example of the hardware configuration of a system equipped in a vehicle;

FIG. 4 is a block diagram schematically showing an example of the functional configuration of an ECU;

FIG. 5 is a diagram showing an example of a software keyboard that is displayed on a center display;

FIG. 6 is a diagram showing an example of a software keyboard that is displayed on an inner display; and

FIG. 7 is a flowchart showing a flow of a display control for software keyboards according to the embodiment.

### DETAILED DESCRIPTION OF EMBODIMENTS

In recent years, a vehicle in which a plurality of displays is provided on a vehicle cabin forward side has been developed. In the vehicle having such a configuration, an interface relevant to a predetermined function of the vehicle is sometimes displayed on a display disposed on a driver's seat forward side in a vehicle cabin. In this case, through the interface displayed on the display, information to be provided to a driver is output, or information indicating a request from the driver is input.

Further, in the vehicle having the above configuration, a display is sometimes disposed also at an intermediate position between a driver's seat and an assistant driver's seat on the vehicle cabin forward side. For allowing the character input to the display disposed at such a position, it is possible that a software keyboard is displayed on the display to which the character input is performed. However, there is a room for improvement in the convenience when the character input is performed by the vehicle driver that is a user of the display device.

In response, an in-vehicle system that is an aspect of the present disclosure is an in-vehicle system including a display device including a plurality of display units that includes at least a pair of first display units and a second display unit, and an information processing device that controls the display device, the first display units are respectively disposed at positions on both lateral sides of a steering wheel, on a driver's seat forward side in a vehicle cabin, so as to protrude to a vehicle rearward side relative to a meter unit arranged in front of the steering wheel, and include touch panels, the second display unit is disposed at an intermediate position between a driver's seat and an assistant driver's seat on the driver's seat forward side in the vehicle cabin, and the information processing device includes a control unit configured to execute displaying a software keyboard for character input to the second display unit, on one of the first display units, when the character input is requested on the second display unit.

The in-vehicle system includes the display device. Further, the display device includes the display units that include at least the first display units and the second display unit. The first display units are respectively disposed at the positions on both lateral sides of the steering wheel, on the driver's seat forward side in the vehicle cabin, so as to protrude to the vehicle rearward side relative to the meter unit arranged in front of the steering wheel. That is, at the driver's seat in the vehicle cabin, each of the first display units is disposed at the vicinity of the steering wheel. Moreover, the first display units include touch panels. Therefore, the first display unit can accept input operation (touch operation) by a driver. Further, the second display unit is disposed at the intermediate position between the driver's seat and the assistant driver's seat on the vehicle cabin forward side.

Further, the in-vehicle system includes the information processing device. The information processing device includes the control unit that controls the display device. Moreover, the control unit displays the software keyboard for the character input to the second display unit, on one of the first display units, when the character input is requested on the second display unit.

When the first display units and the second display unit are disposed in the vehicle cabin as described above, the first display units are positioned so as to be closer to the driver's seat than the second display unit is. More specifically, each of the first display units is positioned at the vicinity of the steering wheel. Since the first display units are disposed at such positions, the touch operation to the first display units is more easily performed by the driver of the vehicle than the touch operation to the second display unit. Hence, in the in-vehicle system according to the present disclosure, even when character input is performed to the second display unit, the software keyboard for the character input to the second display unit is displayed on one of the first display units, by the control unit. Thereby, the driver can perform the character input on the second display unit, by the touch operation to the first display unit. Accordingly, it is possible to enhance the convenience when a user (driver) uses the display device that includes the display units.

Specific embodiments of the present disclosure will be described below based on the drawings. Dimensions, materials, shapes, relative dispositions, and others of constituent components described in the embodiments are not intended to limit the technical scope of the present disclosure thereto, unless otherwise described.

### EMBODIMENT

### Schematic Configuration of System

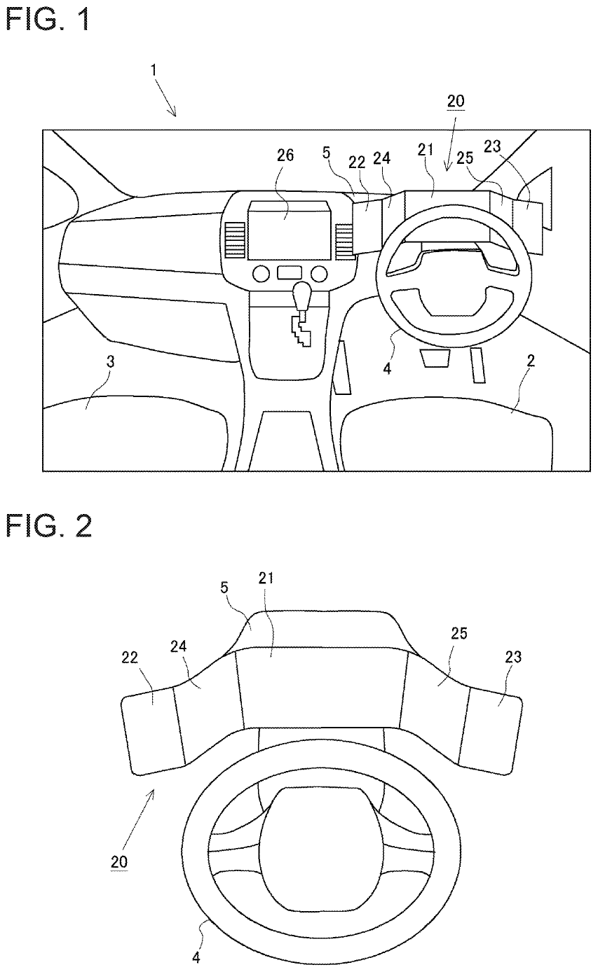

FIG. 1 is a diagram showing the appearance of a vehicle cabin forward portion of a vehicle according to an embodiment. In a vehicle cabin of a vehicle 1, a driver's seat 2 and an assistant driver's seat 3 are provided. The vehicle 1 in the embodiment is a right-hand-drive vehicle, and the driver's seat 2 is provided on the right side with respect to the moving direction of the vehicle 1. A steering wheel 4 is arranged on the forward side of the driver's seat 2. The steering wheel 4 may have a circular shape, or may be a U-shaped steering wheel (a so-called irregular-shaped steering wheel). The steering wheel 4 is connected to a steering device included in the vehicle 1, through a steering column. The steering column is covered with a column cover. Further, the assistant driver's seat 3 is provided on the left side (the left side with respect to the moving direction of the vehicle 1) of the driver's seat 2 in the vehicle cabin of the vehicle 1.

A display device 20 is provided on the vehicle cabin forward side in the vehicle 1. The display device 20 includes a plurality of displays 21, 22, 23, 26. Specifically, the display device 20 includes a meter display 21, an inner display 22, an outer display 23, and a center display 26. The meter display 21 is positioned in front of the steering wheel 4 forward of the driver's seat 2 (at a roughly central portion of a forward portion of the driver's seat 2). The inner display 22 is positioned on an inner side in the vehicle 1, rearward of the meter display 21 in the vehicle 1. The outer display 23 is positioned on an outer side in the vehicle 1, rearward of the meter display 21 in the vehicle 1. The inner display 22 is connected to the meter display 21 through a connection portion 24. The outer display 23 is connected to the meter display 21 through a connection portion 25.

The center display 26 is positioned at the intermediate position between the driver's seat 2 and the assistant driver's seat 3 on the vehicle cabin forward side (at a roughly central portion of the vehicle cabin forward portion). That is, the center display 26 is provided on the assistant driver's seat 3 side of the vehicle cabin forward side, relative to the meter display 21, the inner display 22, and the outer display 23.

The outer side in the vehicle 1 means a side closer to the exterior of the vehicle 1 as viewed from the driver's seat 2, and means the side of a door at the driver's seat 2. Further, the inner side in the vehicle 1 means the side of the assistant driver's seat 3 as viewed from the driver's seat 2, and means the side of a door at the assistant driver's seat 3. For example, in the vehicle 1 in which the steering wheel is provided on the right side in the vehicle 1, the outer side in the vehicle 1 indicates the right side in the vehicle 1, and the inner side in the vehicle 1 indicates the left side in the vehicle 1. Further, for example, in the vehicle 1 in which the steering wheel 4 is provided on the left side in the vehicle 1, the outer side in the vehicle 1 indicates the left side in the vehicle 1, and the inner side in the vehicle 1 indicates the right side in the vehicle 1.

Each of the meter display 21, the inner display 22, the outer display 23, and the center display 26 is a display that includes a touch panel. The meter display 21, the inner display 22, and the outer display 23 may be formed by transforming a single touch panel, or may be formed by combining individual touch screens.

As each touch panel of the displays of the display device 20, for example, a pressure-sensitive touch panel that detects a pressure at which the user presses the panel, or a capacitive touch panel that detects a change in capacitance when the user presses the panel can be employed. Further, for example, each display is a liquid crystal display (LCD), an electroluminescence (EL) panel, or the like. Hereinafter, the touching by the user means that the user makes contact with the touch panel.

Auxiliary information (for example, car navigation information) about driving that is provided to the driver of the vehicle 1 may be displayed on the center display 26. Further, information about entertainment, as exemplified by an audio and a television, may be displayed on the center display 26.

More detailed configurations of the meter display 21, the inner display 22, and the outer display 23 of the display device 20 will be described based on FIG. 2. FIG. 2 is a diagram showing the schematic configuration of the display device 20 and the periphery thereof. The meter display 21 of the display device 20 is fixed on an instrument panel 5. The meter display 21 is a horizontally long display, and the inner display 22 and the outer display 23 are vertically long displays. The meter display 21 is disposed such that a screen is oriented in a vehicle rearward direction, and is disposed parallel to a right-left direction (vehicle-width direction) of the vehicle 1. The meter display 21 may be disposed so as to be slightly inclined and oriented upward.

One end of the connection portion 24 is connected to an end portion on the vehicle inner side of the meter display 21, and the other end of the connection portion 24 is connected to the inner display 22. The inner display 22 is a display that extends from an end portion on the vehicle inner side of the connection portion 24 to the rearward side in the vehicle 1 and the inner side in the vehicle 1. The angle of the inner display 22 with respect to the meter display 21 is smaller than the angle of the connection portion 24 with respect to the meter display 21. Further, the connection portion 24 is curved and is connected to the meter display 21 and the inner display 22. The connection portion 24 includes a curved surface that is concave to the vehicle forward side, at a portion of the connection with the meter display 21, and includes a curved surface that is convex to the vehicle rearward side, at a portion of the connection with the inner display 22. Curved surfaces may be included in the meter display 21 and the inner display 22.

One end of the connection portion 25 is connected to an end portion on the vehicle outer side of the meter display 21, and the other end of the connection portion 25 is connected to the outer display 23. The outer display 23 is a display that extends from an end portion on the vehicle outer side of the connection portion 25 to the rearward side in the vehicle 1 and the outer side in the vehicle 1. The angle of the outer display 23 with respect to the meter display 21 is smaller than the angle of the connection portion 25 with respect to the meter display 21. Further, the connection portion 25 is curved and is connected to the meter display 21 and the outer display 23. The connection portion 25 includes a curved surface that is concave to the vehicle forward side, at a portion of the connection with the meter display 21, and includes a curved surface that is convex to the vehicle rearward side, at a portion of the connection with the outer display 23. A curved surface may be included in the outer display 23.

The steering wheel 4 includes a grasp portion that is a portion that is grasped by the driver. Moreover, in the display device 20, since the meter display 21, the inner display 22, the outer display 23, and the connection portions 24, 25 has the above shapes, the inner display 22 and the outer display 23 are disposed at the vicinity of the grasp portion in the steering wheel 4.

Further, each of the inner display 22 and the outer display 23 has an angle with respect to the right-left direction of the steering wheel 4, and is disposed so as to be inclined to the steering wheel 4 side. That is, the inner display 22 is disposed so as to protrude to the rearward side in the vehicle 1 toward the inner side in the vehicle 1, and the outer display 23 is disposed so as to protrude to the rearward side in the vehicle 1 toward the outer side in the vehicle 1. In this way, each of the inner display 22 and the outer display 23 is disposed so as to be oriented to the driver.

The meter display 21 displays an interface showing information necessary for the traveling of the vehicle 1, as exemplified by the velocity of the vehicle 1, the engine speed (when the vehicle 1 includes an engine), the charge-discharge condition (when the vehicle 1 includes a drive battery), the traveling distance, and the state of an advanced driver-assistance system (ADAS).

The outer display 23 displays interfaces (also referred to as “first interfaces” hereinafter) respectively relevant to a plurality of first predetermined functions of a plurality of functions of the vehicle 1. The first predetermined functions include functions related to the control of the vehicle 1. Further, the inner display 22 displays interfaces (also referred to as “second interfaces” hereinafter) respectively relevant to a plurality of second predetermined functions that is of the plurality of functions of the vehicle 1 and that is different from the first predetermined functions. The second predetermined functions include functions related to the convenience for an occupant of the vehicle 1. The first interfaces displayed on the outer display 23 and the second interfaces displayed on the inner display 22 include operation icons (for example, a switch icon or a button icon) that are operated by the driver of the vehicle 1. Details of the first predetermined function, the second predetermined function, the first interface, and the second interface will be described later.

As described above, the display device 20 is configured such that the inner display 22 and the outer display 23 are provided as a pair, in consideration of the operability for the driver. Further, in the display device 20, the size of the center display 26 is larger than the size of the inner display 22. Further, the size of the center display 26 is larger than the size of the outer display 23. In the embodiment, the meter display 21 corresponds to the “meter unit” according to the present disclosure. Moreover, in the embodiment, the inner display 22 and the outer display 23 corresponds to the “first display unit” according to the present disclosure. Further, in the embodiment, the center display 26 corresponds to the “second display unit” according to the present disclosure.

### Hardware Configuration

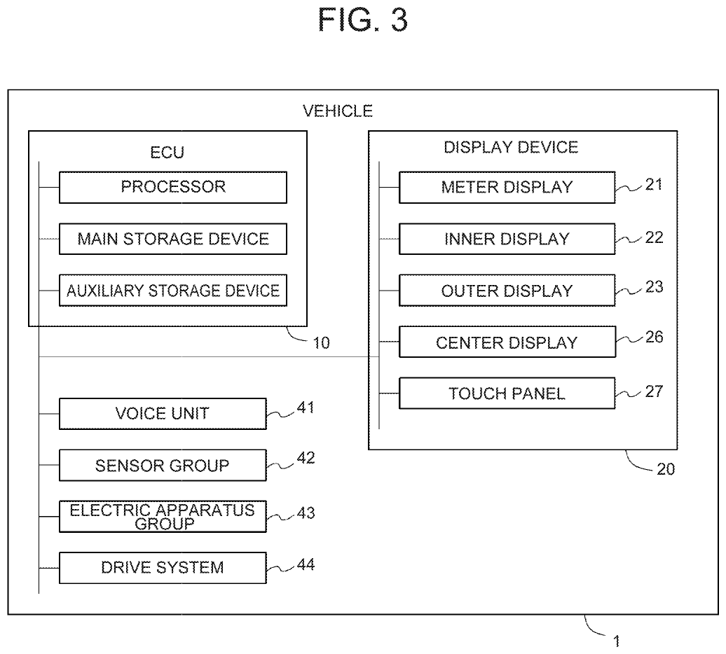

FIG. 3 is a block diagram schematically showing an example of the hardware configuration of a system equipped in the vehicle 1. The system equipped in the vehicle 1 includes an ECU 10, the display device 20, a voice unit 41, a sensor group 42, an electric apparatus group 43, and a drive system 44.

The ECU 10 can be configured as a computer including a processor (a CPU, a GPU, or the like), a main storage device (an RAM, an ROM, or the like), and an auxiliary storage device (an EPROM, a hard disc drive, a removable medium, or the like). In the auxiliary storage device, an operating system (OS), various programs, various tables, and others are stored, and by the execution of programs stored in the auxiliary storage device, it is possible to realize later-described functions (software modules) that match predetermined purposes. However, some or all functions may be realized as hardware modules by hardware circuits such as an ASIC or an FPGA, for example. The ECU 10 is connected with the display device 20, the voice unit 41, the sensor group 42, the electric apparatus group 43, and the drive system 44. The ECU 10 does not always need to be configured by a single hardware device, and may be configured by a plurality of computers. Further, in the embodiment, the ECU 10 corresponds to the “information processing device” according to the present disclosure.

The display device 20 includes the meter display 21, the inner display 22, the outer display 23, the center display 26, and touch panels 27. The touch panel 27 is a unit for detecting the touch operation that is performed to the meter display 21, the inner display 22, the outer display 23, and the center display 26. The touch panel 27 is disposed on each of the meter display 21, the inner display 22, the outer display 23, and the center display 26. Thereby, each display is configured to be capable of being operated by touch. The meter display 21, the inner display 22, the outer display 23, the connection portions 24, 25, and the touch panel 27 may be configured by transforming the shape of a single touch screen.

The voice unit 41 is a unit through which input and output of information are performed by voice. For example, the voice unit 41 may include a speaker and a microphone. The voice unit 41 can acquire voice emitted by the occupant of the vehicle 1. Further, the voice unit 41 can emit voice to the occupant of the vehicle 1.

The sensor group 42 is an aggregate of a plurality of sensors for acquiring sensor data that is used in the traveling of the vehicle 1. The sensors may acquire physical quantities or may acquire image data and the like. The sensor group 42 includes, for example, a sensor that detects the state of the vehicle 1, and a sensor that detects the action of the driver. Specifically, the sensor group 42 may include a velocity sensor, an acceleration sensor, an accelerator operation amount sensor, a brake sensor, a steering angle sensor, an engine speed sensor, a yaw rate sensor, a turn signal switch sensor, a shift position sensor, a GPS sensor, a vehicle interior temperature sensor, a vehicle exterior temperature sensor, a ranging radar, an illuminance sensor, and the like.

The velocity sensor detects the velocity of the vehicle 1. The acceleration sensor detects the acceleration of the vehicle 1. The accelerator operation amount sensor detects the position of an accelerator pedal. The brake sensor detects the position of a brake pedal. The steering angle sensor detects the steering angle of the steering wheel 4. The engine speed sensor detects the speed of the engine. The yaw rate sensor detects the yaw rate of the vehicle 1. The turn signal switch sensor detects the state of a switch for a direction indicator. The shift position sensor detects shift position. The GPS sensor detects position information about the vehicle 1. The vehicle interior temperature sensor detects the temperature of the interior of the vehicle. The vehicle exterior temperature sensor detects the temperature of the exterior of the vehicle. The ranging radar measures the distance to an object. The illuminance sensor detects the brightness of the external environment of the vehicle 1.

The electric apparatus group 43 is an aggregate of electric apparatuses provided in the vehicle 1. For example, the electric apparatus group 43 includes vehicle control devices such as a headlight unit, a wiper actuator, a mirror actuator, and a seat actuator. The electric apparatus group 43 further includes in-vehicle devices having functions other than vehicle control, as exemplified by a navigation device, a multimedia device, and an air conditioner.

The drive system 44 is a system that is constituted by drive devices of the vehicle 1. Examples of the drive device include an engine and/or motor as a dynamic power source, a battery, and a transmission.

### Functional Configuration of ECU

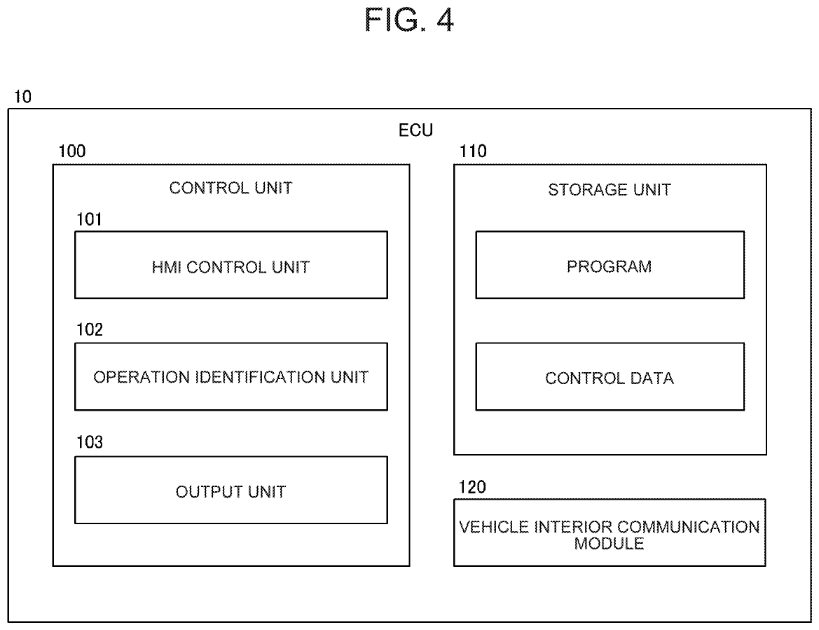

The functional configuration of the ECU 10 will be described based on FIG. 4. FIG. 4 is a block diagram schematically showing an example of the functional configuration of the ECU. The ECU 10 includes a control unit 100, a storage unit 110, and a vehicle interior communication module 120, as functional constituent elements. For example, the control unit 100 is a functional constituent element that is provided when the processor executes various programs stored in an auxiliary storage unit. The display device 20 accepts, through the touch panel 27, a control command from the user that is the occupant of the vehicle 1. At this time, a signal corresponding to the input operation to one of the displays 21, 22, 23, 26 by the user is sent from the touch panel 27 to the ECU 10. Then, in response to the input operation to the display by the user, in the ECU 10, the control unit 100 executes the control of the display device 20, an electric apparatus included in the electric apparatus group 43, or a drive device included in the drive system 44.

The control unit 100 includes a human-machine interface (HMI) control unit 101, an operation identification unit 102, and an output unit 103, as software modules. The HMI control unit 101 generates interfaces relevant to various functions of the vehicle 1. Furthermore, the HMI control unit 101 displays the generated interfaces on the displays included in the display device 20. Further, the interfaces generated by the HMI control unit 101 and displayed on the displays include operation icons that can be operated by the user. The operation icons are icons through which the driver controls various functions of the vehicle 1. The HMI control unit 101 accepts a control command that is input when the user operates the operation icon.

Based on a signal received from the touch panel 27 of the display device 20, the operation identification unit 102 identifies the input operation to the display by the user. For example, the operation identification unit 102 identifies a spot that the user has touched on one of the displays 21, 22, 23, 26 of the display device 20. Further, the operation identification unit 102 identifies the operation content (for example, flick, swipe, tap, pinch, double-tap, long-tap, or multi-tap) of the input operation that the user has performed to one of the displays 21, 22, 23, 26 of the display device 20.

The output unit 103 sends the control command accepted by the HMI control unit 101 or a control signal corresponding to the user's input operation identified by the operation identification unit 102, to an apparatus as a control object (that is, to one of the display device 20, the electric apparatuses included in the electric apparatus group 43, and the drive devices included in the drive system 44). In the apparatus as the control object, the control signal sent by the output unit 103 is received, and thereby, a control corresponding to the control signal is executed.

The storage unit 110 is a functional constituent element that stores information. The storage unit 110 is configured to include a main storage unit and an auxiliary storage unit. The storage unit 110 stores various programs that are executed by the control unit 100 and control data that is used for the execution of various programs.

The vehicle interior communication module 120 is a functional constituent element for connecting the ECU 10 to a vehicle network using a predetermined vehicle interior communication standard. Examples of the predetermined vehicle interior communication standard include Controller Area Network (CAN) and Local Interconnect Network (LIN). The ECU 10 communicates with various devices provided in the vehicle 1, through the vehicle interior communication module 120.

### Interface

On the displays of the display device 20, the interfaces relevant to various functions of the vehicle 1 are displayed by the HMI control unit 101. On this occasion, the HMI control unit 101 displays the first interfaces relevant to the first predetermined functions, on the outer display 23. The first predetermined functions are functions related to the control of the vehicle 1. Examples of the first predetermined function include a headlight control function, a wiper control function, a mirror adjustment function, a driving mode setting function, a seat position adjustment function, and an ADAS setting function. Further, the HMI control unit 101 displays the second interfaces relevant to the second predetermined functions, on the inner display 22. The second predetermined functions are functions related to the convenience for the occupant of the vehicle 1. Examples of the second predetermined function include an air-conditioner setting function, a hands-free call function, and an agent function (a function to dialogue with an AI assistant).

In the display device 20, respective output destinations of the interfaces relevant to various functions of the vehicle 1 are allocated depending on types of the functions, as described above. Thereby, the driver can recognize easily and intuitively whether an interface for which the driver wants to perform the check of the display content or the operation is output on the inner display 22 or on the outer display 23. Further, operation surfaces of the touch panels 27 included in the inner display 22 and the outer display 23 are disposed at the vicinity of the steering wheel 4. Thereby, when the driver executes various controls by the touch operation to the inner display 22 or the outer display 23, it is possible to minimize the movement amounts of the visual line and hand of the driver.

Further, the HMI control unit 101 may display, on the center display 26, an interface such as a navigation screen or an entertainment screen. The navigation screen is a screen including map information, route information and others that are provided by a navigation function of the navigation device. The entertainment screen is a screen including information, contents, and others that are provided by an audio function, a television or radio function, a video content output function, or the like of the multimedia device.

Interfaces that are respectively displayed on the inner display 22, the outer display 23, and the center display 26 are switched by the HMI control unit 101. That is, for each of the inner display 22, the outer display 23, and the center display 26, one interface selected from a plurality of interfaces corresponding to the display is displayed. Moreover, for each display, the user can switch the display content on the display, for example, by performing a predetermined touch operation such as left or right swipe.

### Displaying of Software Keyboard

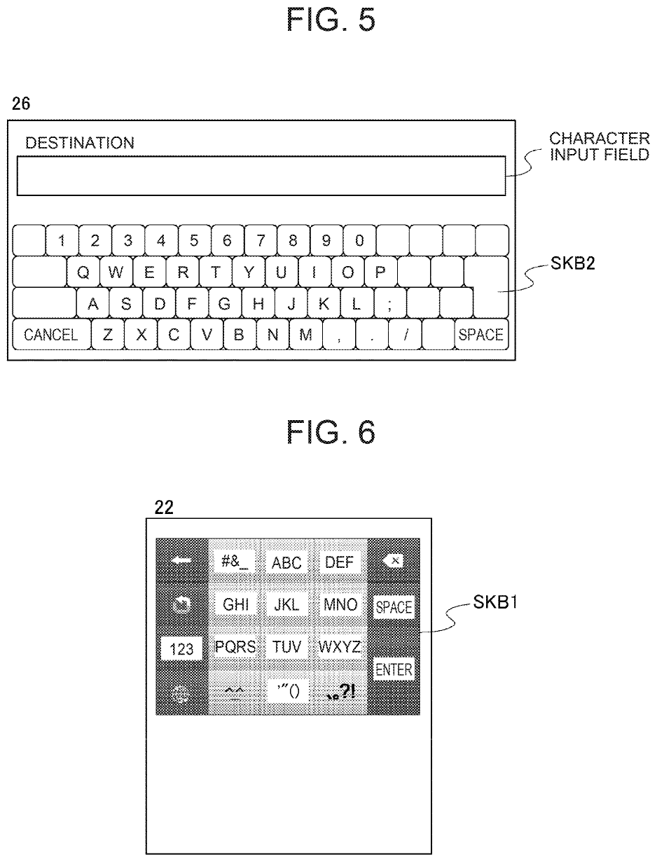

Next, the displaying of software keyboards on the displays of the display device 20 will be described based on FIG. 5 and FIG. 6. In the display device 20, character input is sometimes requested on the center display 26. Specifically, when the navigation screen is displayed on the center display 26, the user sometimes needs to perform the character input of information about a destination and the like. Further, when the entertainment screen is displayed on the center display 26, the user sometimes needs to perform the character input of information about a content or the like that the user wants. In such cases, the HMI control unit 101 displays a character input field on the center display 26.

In the display device 20, not only the inner display 22 and the outer display 23 but also the center display 26 includes the touch panel 27. Hence, when the HMI control unit 101 displays the character input field on the center display 26, the HMI control unit 101 displays, on the center display 26, a software keyboard for the character input to the character input field. Thereby, the user can perform the character input to the character input field displayed on the center display 26, through the software keyboard displayed on the center display 26.

However, as described above, in the vehicle 1 according to the embodiment, the inner display 22 is disposed at such a position that the operation is more easily performed by the driver of the vehicle 1, compared to the center display 26. Hence, in the embodiment, in the case where the HMI control unit 101 displays the character input field on the center display 26, the HMI control unit 101 displays the software keyboard for the character input to the character input field, not only on the center display 26 but also on the inner display 22.

FIG. 5 is a diagram showing an example of a software keyboard that is displayed on the center display. FIG. 6 is a diagram showing an example of a software keyboard that is displayed on the inner display. Hereinafter, the software keyboard that is displayed on the inner display 22 is also referred to as a first software keyboard SKB1. Further, the software keyboard that is displayed on the center display 26 is also referred to as a second software keyboard SKB2.

As shown in FIG. 5, on the center display 26, the second software keyboard SKB2 is displayed together with the character input field (for example, an input field for inputting the destination of the vehicle 1 for navigation). Moreover, when the character input field and the second software keyboard SKB2 are displayed on the center display 26, the first software keyboard SKB1 is displayed on the inner display 22, as shown in FIG. 6.

Since the first software keyboard SKB1 is displayed on the inner display 22 in this way, the driver can perform the character input to the character input field on the center display 26, by the touch operation to the inner display 22. Thereby, it is possible to reduce the movement amount of the visual line of the driver and the movement amount of the hand, compared to the case where the driver performs the character input to the character input field through the second software keyboard SKB2 displayed on the center display 26. Accordingly, since the first software keyboard SKB1 is displayed on the inner display 22, the driver can more easily perform the character input to the character input field on the center display 26.

Further, as shown in FIG. 5 and FIG. 6, the first software keyboard SKB1 displayed on the inner display 22 and the second software keyboard SKB2 displayed on the center display 26 are different in form. As described above, in the display device 20, the size of the center display 26 is larger than the size of the inner display 22. In other words, the size of the inner display 22 is smaller than the size of the center display 26. Therefore, if a software keyboard having the same form as the second software keyboard SKB2 displayed on the center display 26 is displayed on the inner display 22, it is sometimes necessary to extremely reduce the magnitude of each key in the software keyboard displayed on the inner display 22. However, when the size of each key in the software keyboard is small, there is fear of decease in the operability for the input operation.

Therefore, the first software keyboard SKB1 has such a form that the number of keys that are displayed in the first software keyboard SKB1 is smaller than the number of keys that are displayed in the second software keyboard SKB2. For example, the second software keyboard SKB2 may be QWERTY type keyboard, and the first software keyboard SKB1 may be a ten-key type keyboard. The form of the first software keyboard SKB1 and the form of the second software keyboard SKB2 are previously determined, and are stored in the storage unit 110. In this way, the form depending on the size of the inner display 22 is adopted as the form of the first software keyboard SKB1, and thereby, it is possible to restrain the magnitude of each key in the first software keyboard SKB1 from becoming excessively small. As a result, it is possible to enhance the operability for the input operation with use of the first software keyboard SKB1.

Even when the second software keyboard SKB2 is displayed on the center display 26 and therewith the first software keyboard SKB1 is displayed on the inner display 22, only one software keyboard is actually used for the character input. Hence, in the embodiment, after the first software keyboard SKB1 is displayed on the inner display 22 and the second software keyboard SKB2 is displayed on the center display 26, in the case where the touch operation to one software keyboard is detected by the touch panel 27, the HMI control unit 101 hides the other software keyboard.

### Control Flow

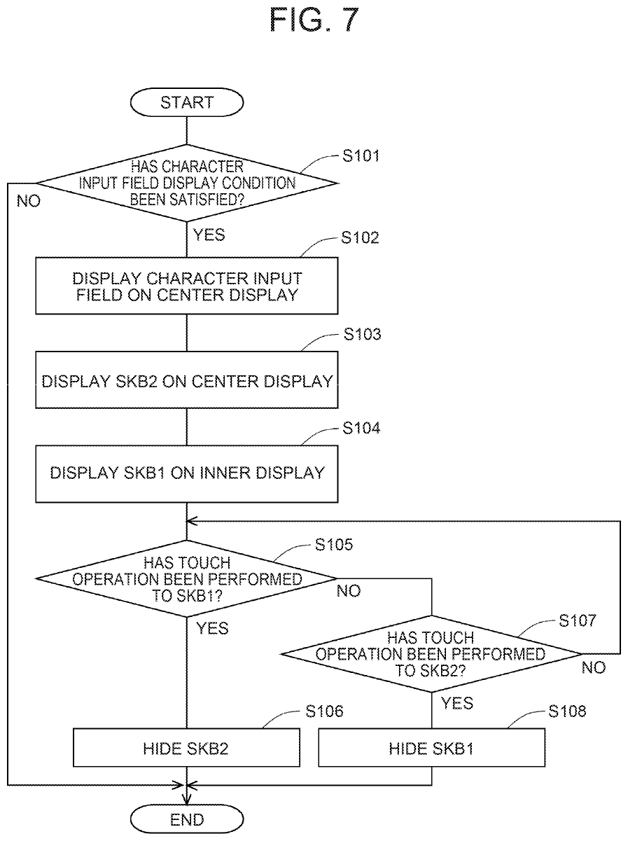

A flow of a display control for software keyboards in the display device 20 will be described below based on FIG. 7. FIG. 7 is a flowchart showing the flow of the display control for software keyboards according to the embodiment. The flow is executed by the control unit 100 of the ECU 10.

In the flow, first, in S101, it is determined whether a condition (character input field display condition) for displaying the character input field on the center display 26 has been satisfied. On this occasion, it is determined that the character input field display condition has been satisfied, when the character input is necessary in the interface currently displayed on the center display 26. In the case where the negative determination is made in S101, the execution of the flow is ended once.

On the other hand, in the case where the positive determination is made in

S101, a process in S102 is next executed. In S102, the character input field is displayed on the center display 26. Next, in S103, the second software keyboard SKB2 is displayed on the center display 26. Next, in S104, the first software keyboard SKB1 is displayed on the inner display 22. The processes in S102 to S104 are executed by the HMI control unit 101. Moreover, in S103 and S104, the HMI control unit 101 displays the first software keyboard SKB1 and the second software keyboard SKB2 in forms stored in the storage unit 110, respectively.

Therefore, when S103 and S104 are executed, the second software keyboard SKB2 exemplified in FIG. 5 is displayed on the center display 26, and therewith, the first software keyboard SKB1 exemplified in FIG. 6 is displayed on the inner display 22. Thereby, the driver can select the first software keyboard SKB1 or the second software keyboard SKB2, to perform the character input to the character input field displayed on the center display 26.

In the flow, following S104, a process in S105 is executed. In S105, it is determined whether the touch operation has been performed to the first software keyboard SKB1 displayed on the inner display 22. In the case where the positive determination is made in S105, it can be determined that the character input to the character input field on the center display 26 has been performed through the first software keyboard SKB1. In this case, a process in S106 is next executed. In S106, the second software keyboard SKB2 is hidden on the center display 26. Thereafter, the execution of the flow is ended once.

On the other hand, in the case where the negative determination is made in S105, a process in S107 is next executed. In S107, it is determined whether the touch operation has been performed to the second software keyboard SKB2 displayed on the center display 26. In the case where the negative determination is made in S107, it can be determined that the operation for the character input has not been yet performed to either of the first software keyboard SKB1 and the second software keyboard SKB2. In this case, the process in S105 is executed again.

On the other hand, in the case where the positive determination is made in S107, it can be determined that the character input to the character input field on the center display 26 has been performed through the second software keyboard SKB2. In this case, a process in S108 is next executed. In S108, the first software keyboard SKB1 is hidden on the inner display 22. Thereafter, the execution of the flow is ended once. The processes in S105 and S107 are executed by the operation identification unit 102. Further, the processes in S106 and S108 are executed by the HMI control unit 101.

With the above control flow, it is possible to display the first software keyboard SKB1 on the inner display 22, when the character input is requested on the center display 26. As described, in the display device 20, the inner display 22 and the outer display 23 are configured as a pair. Therefore, similarly to the inner display 22, the outer display 23 is disposed at such a position that the operation is more easily performed by the driver of the vehicle 1, compared to the center display 26. Hence, in the embodiment, in the case where the HMI control unit 101 displays the character input field on the center display 26, the HMI control unit 101 may display the first software keyboard SKB1 on the outer display 23, instead of the inner display 22.

Further, in the embodiment, in the case where the HMI control unit 101 displays the character input field on the center display 26, the HMI control unit 101 does not always need to display the second software keyboard SKB2 on the center display 26. That is, the HMI control unit 101 may display the software keyboard only on the inner display 22 (or on the outer display 23), without displaying the software keyboard on the center display 26. As long as the first software keyboard SKB1 is displayed on the inner display 22 (or only on the outer display 23), the driver can perform the character input to the character input field on the center display 26, through the first software keyboard SKB1.

However, since the first software keyboard SKB1 is displayed on the inner display 22 and furthermore the second software keyboard SKB2 is displayed on the center display 26 as described above, the driver can select the software keyboard to which the touch operation for the character input is performed, from the two software keyboards. Further, in the vehicle 1, a passenger other than the driver sometimes exists in the assistant driver's seat 3. In this case, when the second software keyboard SKB2 is displayed on the center display 26, the passenger can perform the touch operation for the character input, using the second software keyboard SKB2.

Further, with the above control flow, in the case where the character input to the character input filed on the center display 26 has been performed through the first software keyboard SKB1, the second software keyboard SKB2 displayed on the center display 26 is automatically hidden. Thereby, the software keyboard is prevented from continuing to be needlessly displayed on the center display 26. Accordingly, even when the character input to the character input field on the center display 26 is performed, more useful information can be displayed on the center display 26.

Further, with the above control flow, in the case where the character input to the character input field on the center display 26 has been performed through the second software keyboard SKB2, the first software keyboard SKB1 displayed on the inner display 22 is automatically hidden. Thereby, the software keyboard is prevented from continuing to be needlessly displayed on the inner display 22. Accordingly, even when the character input to the character input field on the center display 26 is performed, more useful information can be displayed on the inner display 22.

### Other Embodiments

The above embodiment is merely an example, and the present disclosure can be implemented with changes made thereto as appropriate within such a range that no departure is made from the gist of the present disclosure. Further, the processes and means described in the present disclosure can be implemented in arbitrary combinations to such an extent that no technical inconsistency arises.

Further, a process that has been described as being performed by one device may be shared and executed by a plurality of devices. Alternatively, processes that have been described as being performed by different devices may be executed by one device. In the computer system, by what hardware configuration (server configuration) each function is realized can be flexibly changed.

The present disclosure can also be realized by supplying a computer program provided with the functions described in the above embodiment to a computer, and making one or more processors included in the computer read and execute the program. Such a computer program may be provided to a computer by a non-transitory computer-readable storage medium that can be connected to a system bus of the computer, or may be provided to a computer through a network. Examples of the non-transitory computer-readable storage medium include arbitrary types of discs such as magnetic discs (a floppy (R) disc, a hard disc drive (HDD), and the like) and optical discs (a CD-ROM, a DVD disc, a Blu-ray disc, and the like), and arbitrary types of media suitable for storing electronic instructions, as exemplified by a read-only memory (ROM), a random-access memory (RAM), an EPROM, an EEPROM, a magnetic card, a flash memory, and an optical card.

What is claimed is:

1. An in-vehicle system comprising:
a display device including a plurality of displays that include at least a pair of first displays and a second display; and
one or more processors configured to control the display device, wherein:
the first displays include touch panels;
the first displays are respectively disposed at positions on both lateral sides of a steering wheel, on a driver's seat forward side in a vehicle cabin, so as to protrude to a vehicle rearward side relative to a meter, the meter being arranged in front of the steering wheel;
the second display is disposed at an intermediate position between a driver's seat and an assistant driver's seat on the driver's seat forward side in the vehicle cabin; and
the one or more processors are configured to execute displaying a software keyboard for character input to the second display, on one of the first displays, when the character input is requested on the second display.

2. The in-vehicle system according to claim 1, wherein:
in the display device, the second display also includes a touch panel;
the software keyboard that is displayed on the one of the first displays is a first software keyboard; and
the one or more processors are configured to further execute displaying a second software keyboard for the character input to the second display, on the second display, in addition to the displaying the first software keyboard on the one of the first displays, when the character input is requested on the second display.

3. The in-vehicle system according to claim 2, wherein:
in the display device, a size of the second display is larger than a size of the one of the first displays; and
the first software keyboard has such a form that the number of keys that are displayed in the first software keyboard is smaller than the number of keys that are displayed in the second software keyboard.

4. The in-vehicle system according to claim 2, wherein the one or more processors are configured to hide the second software keyboard on the second display in a case where touch operation to the first software keyboard is detected when the first software keyboard is displayed on the one of the first displays and the second software keyboard is displayed on the second display.

5. The in-vehicle system according to claim 2, wherein the one or more processors are configured to hide the first software keyboard on the one of the first displays in a case where touch operation to the second software keyboard is detected when the first software keyboard is displayed on the one of the first displays and the second software keyboard is displayed on the second display.

6. A vehicle comprising the in-vehicle system according to claim 1.

7. An information processing device comprising one or more processors configured to control a display device including a plurality of displays that include at least a pair of first displays and a second display, wherein:
the first displays include touch panels;
the first displays are respectively disposed at positions on both lateral sides of a steering wheel, on a driver's seat forward side in a vehicle cabin, so as to protrude to a vehicle rearward side relative to a meter, the meter being arranged in front of the steering wheel;
the second display is disposed at an intermediate position between a driver's seat and an assistant driver's seat on the driver's seat forward side in the vehicle cabin; and
the one or more processors are configured to execute displaying a software keyboard for character input to the second display, on one of the first displays, when the character input is requested on the second display.

8. The information processing device according to claim 7, wherein:
in the display device, the second display includes a touch panel;
the software keyboard that is displayed on the one of the first displays is a first software keyboard; and
the one or more processors are configured to further execute displaying a second software keyboard for the character input to the second display, on the second display, in addition to the displaying the first software keyboard on the one of the first displays, when the character input is requested on the second display.

9. The information processing device according to claim 8, wherein:
in the display device, a size of the second display is larger than a size of the one of the first displays; and
the first software keyboard has such a form that the number of keys that are displayed in the first software keyboard is smaller than the number of keys that are displayed in the second software keyboard.

10. The information processing device according to claim 8, wherein the one or more processors are configured to hide the second software keyboard on the second display in a case where touch operation to the first software keyboard is detected when the first software keyboard is displayed on the one of the first displays and the second software keyboard is displayed on the second display.

11. The information processing device according to claim 8, wherein the one or more processors are configured to hide the first software keyboard on the one of the first displays in a case where touch operation to the second software keyboard is detected when the first software keyboard is displayed on the one of the first displays and the second software keyboard is displayed on the second display.
